(19) United States
(12) Patent Application Publication
(10) Pub. No.: US 2008/0245484 A1
(43) Pub. Date: Oct. 9, 2008

(54) Overhead door cable engagement apparatus

(75) Inventor: John Tillman, Southbury, CT (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: DL Manufacturing, North Syracuse, NY (US)

(21) Appl. No.: 11/732,618

(22) Filed: Apr. 4, 2007

(51) Int. Cl. E05F 15/20

(52) U.S. Cl. 160/7; 160/193

(57) ABSTRACT

A cable-and-pulley mounted overhead door includes a mechanism for sensing when the cable is tending to slacken and to automatically take-up the slack so as to thereby prevent the cable from disengaging from its pulley. When the overhead door includes an automated drive system, provision is further made for sensing when the take up of slack has progressed to a determined degree and to responsively turn off the automated drive system.

### FIELD OF THE INVENTION

This invention relates generally to overhead doors and, more particularly, to a method and apparatus for preventing a door lift cable from disengaging from its mounting pulley.

Overhead doors are used to occlude openings in structures such as warehouses, factories, and other commercial establishments. Typically, such a door is comprised of a series of panels hinged together and moveable between a doorway blocking position to an overhead storage position. Accordingly, the doors can be relatively heavy for an operator to move especially when moving the door against gravity, i.e. to the upward position.

One approach to solving the weight problem is that of using one or more torsion springs, which are usually located at the top of the doorway for biasing the door to an upward position. Thus, when the door is moving upwardly, the spring is being unwound, and when the door is being moved to a downward position, the spring is being wound, or the operator is working against the tension of the springs.

Another device that is helpful in offsetting the effect of gravity is that of using a counterweight such that the door is attached to one end of a pulley mounted cable and a counterweight is attached to the other end thereof so as to substantially balance the weight of the door and allow easy up and down movement by the operator.

Another approach is a fully mechanized system wherein an electric drive unit is selectively actuated to rotate the cable shaft to either wind up the cable on the pulley to raise the door or to unwind the cable on the pulley to lower the door. Such a drive unit is normally programmed to automatically turn off when the door reaches its fully downward position. However, if an object of any substantial size is located under the door, as occasionally happens, then the drive unit will continue to unwind the cable, with the result being that the cable slackens and often comes off the pulley. The system is then useless until the cable is returned to its proper position on the pulley, a process which can be relatively difficult and time consuming since the pulley is located at a rather high position above the doorway.

The problem of the cable slackening is also true in manually operated doors that simply have the torsion springs or the counterweight as discussed hereinabove. That is, a sudden stopping of the door by an object such as discussed hereinabove when the door is in its downward movement, or possibly even a sudden stopping of the door when it reaches the floor, may result in the cable continuing to move such that it is slackened and may allow one or more windings to come off of the pulley.

What is needed is a method and apparatus for preventing such occurrences.

### SUMMARY OF THE INVENTION

Briefly, in accordance with one aspect of the invention, provision is made for sensing when the cable tends to slacken and to responsively take up the slack as it occurs.

In accordance with another aspect of the invention, a biasing mechanism moves to take up the slack in the cable.

In accordance with another aspect of the invention, a cable engagement apparatus is installed on each side of the doorway adjacent the downwardly extending cable, with each having a biasing mechanism to take out the slack in its associated cable.

In accordance with another aspect of the invention, when the door includes an automated driving system, at least one of the cable engagement apparatuses includes a switch which, when a slack absorbing device has been moved to a predetermined position, is activated to turn off the driving system. A reset switch can then be actuated to continue operation after the object has been removed from its position under the door.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is a perspective view of a loading dock door with the present invention incorporated therein.

FIG. 2 is a partial view thereof showing the cable engagement apparatus of the present invention as installed.

FIG. 3 is a front view of the cable engagement apparatus.

FIG. 4 is a right side view thereof.

FIG. 5 is a perspective view of the switch portion thereof.

FIG. 6 is a perspective view of a left cable engagement apparatus in its normal operating position.

FIG. 7 is a perspective view of a left side cable engagement apparatus as shown in a position just prior to tripping the switch.

### DESCRIPTION OF THE PREFERRED EMBODIMENT

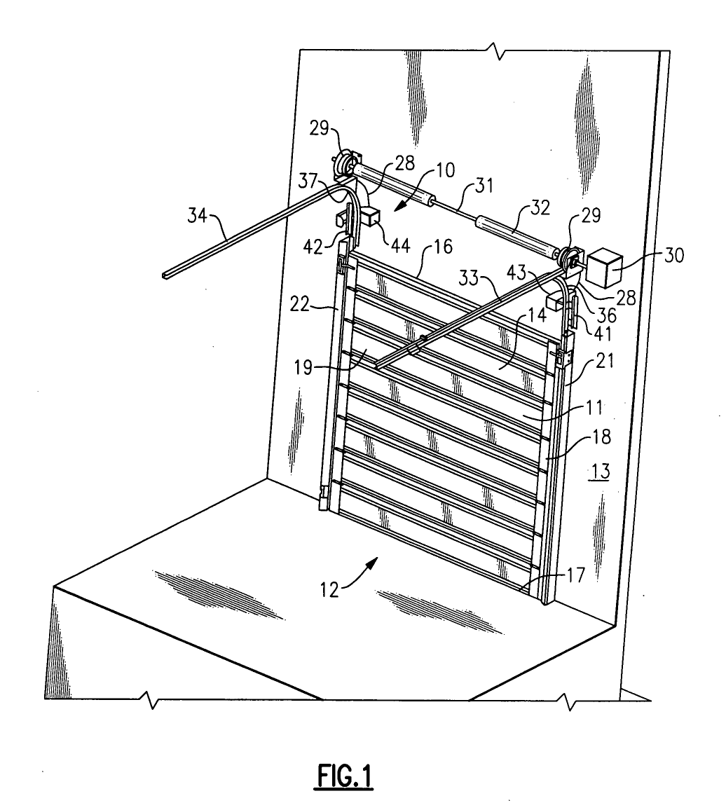

Referring now to FIG. 1, the invention is generally shown at 10 as applied to an overhead door 11 which is mounted in a vertically orientated, closed position to close an opening 12 in a building side wall 13. The door 11 is comprised of a plurality of panels 14 which are hingedly connected at their edges such that the door 11 is flexible to permit its movement around a curved track as it is moved to an open and stored horizontal position. The door 111 has upper and lower edges 16 and 17 and side edges 18 and 19.

Mounted to the wall 13 on either side of the door 11 are vertical support members 21 and 22. The door 11 is supportably mounted within the vertical support members 21 and 22 in a manner in which permits the door to be slidably moved in the grooves of the support members 21 and 22 so as to open and close the door.

Considering now the manner and structure for moving the door 11 to an open position, a lift bracket (not shown) is attached to each door side edge 18 and 19 at a point near the bottom of the door 11 and a cable 28 is secured to the lift bracket. The cable 28 passes upwardly to be wound around a pulley 29 mounted on a shaft 31. A torsion spring 32 mounted to the shaft 31 biases the rotation of the shaft 31 such that the door 11 is biased to move in the upward direction.

It should be recognized that other mechanisms for opening and closing the door can be used while remaining within the scope of the invention. For example, rather than the pulley 29 and spring 32, the cable may be secured to a counterweight to provide the biasing effect, and the door 11 may be opened and closed manually by an attendant.

It has now become common to mechanize the opening of the door by providing an electrically powered actuator operator box 30 mechanically attached to one end of the shaft 31 to selectively rotate the shaft in the proper direction to open or close the door 11.

It should be mentioned that the mounting of warehouse doors is generally accomplished in a manner which allows the doors to be stored in the horizontal, oblique, or upright open positions. As shown in FIG. 1, a horizontal disposition is shown wherein a pair of horizontal rails or tracks 33 and 34 are provided to guide the movement of the door 11 to an open/storage position. Also, in order to bridge the movement of the door 11 between the vertical primary track members 23 and the tracks 33 and 34, arcuate track members 36 and 37 are provided as shown. In operation, the doors 11 are usually in a fully closed position as shown but are moved to the fully opened position when loading or unloading freight. Thus, for the door to be in an intermediate position is somewhat out of the ordinary. One situation that arises is when the door is being moved to a closed position and there is an object under the door which prevents it from being fully closed. If this occurs, the pulleys 29 may continue to rotate such that the cable is slackened and may be disengaged from the sheath(s) of the pulley. This can occur in a manually operated door, but is even more likely to occur when the automated system is installed. That is, the operator 30 is designed to move the door to a fully opened or fully closed position. When the door is stopped from its movement to a fully closed position, the operator 30 tends to continue to operate for a time period which allows the shaft 31 to continue to rotate and the cable to become slack and to slip off its pulley. The present invention is intended to address this problem.

Mounted on the wall 13 between the vertical support members 21 and 22 and their respective pulleys 29 are mounting brackets 41 and 42 which are L-shaped in cross section and provide a means for mounting the cable engagement apparatus 43 and 44 on either side of the door as shown. The purpose of these is to automatically take up the slack in the cable when that occurs so as to thereby prevent the undesirable occurrence of the cable coming off the pulleys 29.

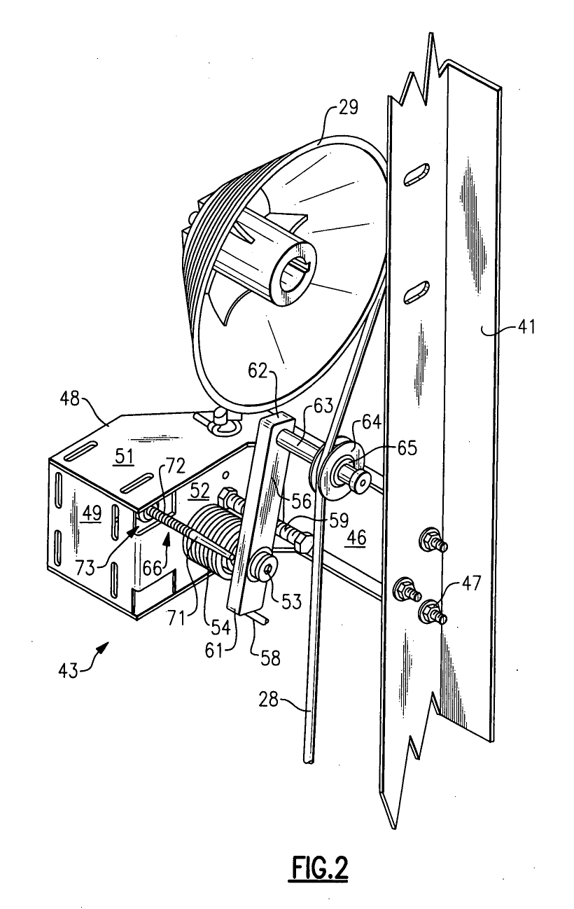

Referring now to FIG. 2, the right mounting rail 41 is shown with its cable engagement apparatus 43 attached thereto. The cable engagement apparatus 43 includes an extender arm 46 which is attached to the mounting rail 41 at its one end by a plurality of bolts 47. Integrally attached to the other end of the extender arm 46 is a box-like housing 48 having a front wall 49, a top wall 51, and an outer wall 52.

Secured to the outer wall 52 and extending toward the mounting rail 41 is a mounting shaft 53, on which is coaxially mounted a torsion spring 54 and a lever arm 56. As will be seen, the torsion spring has its one end 57 secured to the outer wall 52 and its other end 58 secured to one end of the lever end 56. In this way, the torsion spring 54 acts to bias the lever arm 56 to rotate in the counterclockwise direction as seen in FIG. 2.

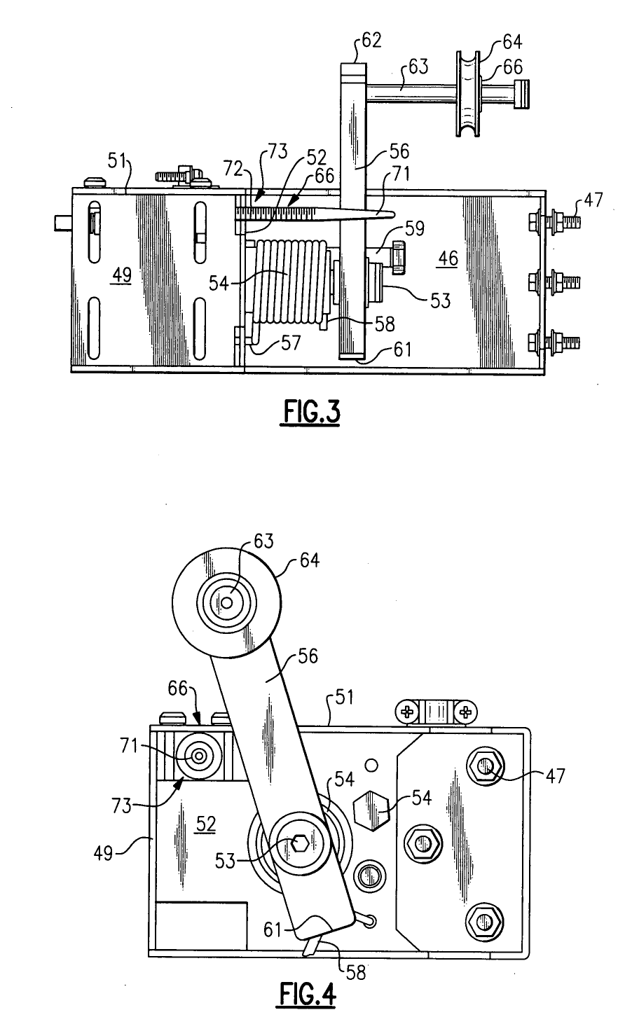

Also attached to the outer wall 52 and extending toward the mounting rail 41 is a stop bolt 59 which extends outwardly from the front wall 52 to a greater extent than the lever arm 56 as shown in FIG. 3. The purpose of the stop bolt 59 is to eventually engage the one side of the lever arm 56 near its bottom end 61 such that the freedom of movement in the counterclockwise direction is limited. This feature will be more fully described hereinafter.

Attached to the lever arm 56 near its top end 62, and extending outwardly toward the mounting rail 41 is a slide shaft 63 with a relatively small pulley 64 rotatable and slidably, mounted thereon. The pulley 64 is intended to not only rotate on the slide shaft 63 so as to allow rotating engagement with the cable 28, but also to slide between the two ends of the slide shaft 63 to accommodate the various positions of the cable 28 on the drum of the pulley 29. Accordingly, the pulley 64 preferably includes a bearing 65 which facilitates this movement.

The manner in which the cable engagement apparatus 43 is connected to and operates with a conventional cable and pulley system is shown in FIG. 2. The cable 28 which normally comes off the larger sheath end of the pulley 29 and passes downwardly to the door is flexed forwardly to fit over the forward edge of the pulley 64 as shown. The cable 28 will normally be taut so as to overcome the counterclockwise biased movement of the lever arm 56 such that the lever arm remains in the position as shown in FIG. 2. However, in the event that the cable 28 tends to slacken in situations as described hereinabove, the biasing movement of the lever arm 56 will automatically take up the slack in the cable 28 as the lever arm 56 is biased to the counterclockwise position. In this way, the cable 28 is prevented from becoming so slack as to allow it to disengage from the drum of the pulley 29.

It should be recognized that the cable engagement apparatus as described hereinabove, and as shown in FIGS. 2-4, is applicable to doors which are opened and closed by manual operation or by an automated drive system. In the later case, however, it is desirable to provide a further function, i.e. that of automatically turning off the drive mechanism when the cable engagement apparatus has been activated and the lever arm 56 has been rotated to a certain position. For that purpose, a mechanically actuated switch 66 is provided as shown in FIGS. 2-5.

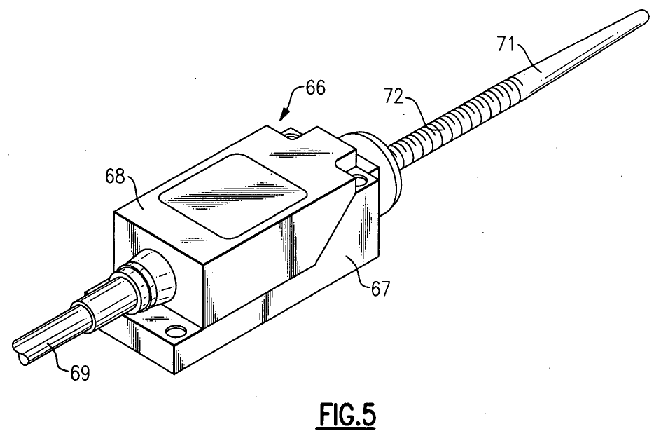

As will be seen in FIG. 5, the switch apparatus 66 includes a base member 67 to which is attached a housing 68. Within the housing 68 is contained an electrical switch which is mechanically triggered to send a signal along a lead 69 to the operator (see FIG. 1) to turn off the mechanism within the operator 30 such that the shaft 31 discontinues its rotation.

At one end of the housing 68 is a probe 71, which is fabricated of a flexible material such as plastic or the like. A coil spring 72 is disposed over the probe 71 to provide a resiliency thereto.

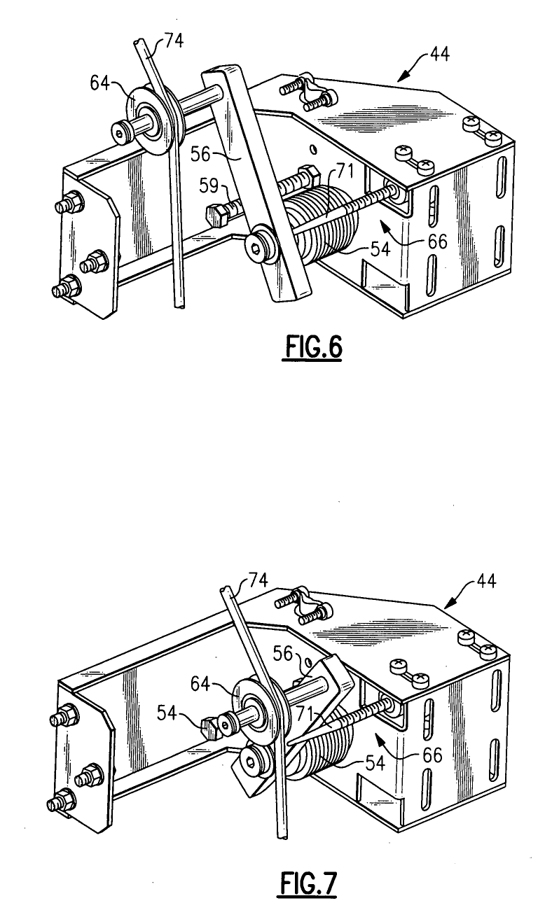

As shown in FIGS. 2-4, the switch apparatus 66 is mounted inside the housing 48 such that its probe 71 extends outwardly through an opening 73. The switch apparatus 66 is then so positioned with respect to the lever arm 56 as to be activated by the biased rotation of the lever arm 56 when a slack occurs in the cable 28 and the lever arm 56 is moved to a predetermined position. This movement can be seen in FIGS. 6 and 7.

In FIGS. 6 and 7, the left side cable engagement apparatus 44 is shown in its normal position in FIG. 6 and in its switch actuating position in FIG. 7. In this regard, it should be recognized that the left side cable engagement apparatus 44 is a mirror image of that of the right side cable engagement apparatus 43. The structure and method of operation is therefore identical to that of the cable engagement apparatus 43 except that in the right side cable engagement apparatus, the lever arm is biased to rotate in a clockwise rather than a counterclockwise direction.

As shown in FIG. 6, the cable 74 engages the pulley 64 to hold the lever arm 56 in a “loaded” position against the bias of the torsion spring 54. So long as the cable 74 is taut, the lever arm 56 will be held in that position. However, when the cable 74 tends to slacken, such as when the door descends to rest against an object as described hereinabove, then the cable will tend to slacken, and the biasing action of the torsion spring 54 will cause the lever arm 56 to rotate to take up that slack. This action, by itself, will prevent the disengagement of the cable 74 from the pulley drum as might otherwise occur. Both manually operated doors and mechanized driven doors will benefit from this feature.

In the case of mechanized doors, the switch apparatus 66 will further come into play to shut down the operation of the operator 30. This will be seen in FIG. 7 wherein the lever arm 56 has been rotated to overcome the slack in the cable and when it reaches the position as shown, it engages the probe 71 to activate the switch 66 so as to thereby shut down the operator 30. The lever arm 56 and its biasing torsion spring 54, however, will continue to operate to take up any slack in the cable 74 by further rotation of the lever arm 56. When the lever arm 56 reaches the position of the stop bolt 59, the lever arm will be prevented from further rotation even though some tension may remain in the torsion spring 54. A reset switch can then be actuated to continue operation, after the object has been removed from its position under the door.

While the invention has be described in terms of use for overcoming the problem of cable disengagement when the door meets an object to prevent its being fully closed, it should be recognized that the invention is intended, and will operate, to take up cable slack and prevent pulley disengagement at anytime that this may tend to occur. For example, even though overhead door systems are generally designed such that all movement stops when the door comes to the fully closed position, because of the inertia of the rapidly descending door, there may still be some tendency for the cable to continue to move and thereby become slackened to the point where it could be disengaged from its pulley. The present invention is intended to correct this problem.

It should also be recognized that, although the present invention has been described in terms of use with a warehouse door, it may also be useful in non-industrial settings such as with an overhead door in a residential garage, for example.

While the present invention has been described with reference to a particular preferred embodiment and the accompanying drawings, it will be understood by those skilled in the art that the invention is not limited to the preferred embodiment and various modifications can be made thereto without departing from the scope of the invention as defined in the following claims.

We claim:

1. A method of preventing the derailing of a lift cable from the pulley of an overhead door assembly comprising the steps of:
sensing when the downwardly extending cable is caused to slacken; and
responsively taking the slack out of the cable as it tends to occur.

2. A method as set forth in claim 1 wherein said pulley is of the multi sheave type.

3. A method as set forth in claim 2 wherein said pulley is positioned with its largest sheave on an outer side.

4. A method as set forth in claim 3 wherein the driving device winds the cable on the pulley from the larger sheave to the smaller sheaves.

5. A method as set forth in claim 1 wherein said sensing step is accomplished by way of a biasing mechanism which engages the downwardly extending cable and moves it generally transversely to prevent its slackening.

6. A method as set forth in claim 1 wherein the overhead door assembly is of the type having a driving apparatus that is adapted to rotate the pulley shaft until the door is in a fully down position and further including the further step of responsively turning off the driving device to prevent the further rotation of the pulley shaft.

7. A method as set forth in claim 6 wherein the slack is taken out by a rotating lever arm and further wherein, when the lever arm moves to a predetermined position, a switch is actuated to turn off the driving apparatus.

8. A method as set forth in claim 6 and including the further step of resetting the driving device after the obstruction has been removed.

9. An overhead door assembly of the type having its vertical movement being controlled by an electrically driven actuator for selectively rotating a shaft and an attached pulley for winding/unwinding a door cable on the pulley to raise/lower the door and further wherein, when an obstacle is disposed under the door to prevent its movement to a fully down position, the actuator continues to operate and tends to cause a slackening of the cable which can cause the cable to come off the pulley, comprising:
a mechanism for sensing when the cable is tending to slacken; and
a biasing mechanism which engages the downwardly extending cable and moves it generally transversely to prevent its slackening.

10. An overhead door assembly as set forth in claim 9 wherein said sensing and biasing mechanisms includes an engaging member that is moved generally transversely to the direction of the downwardly extending cable.

11. An overhead door assembly as set forth in claim 10 and including a lever arm and biasing spring attached to said engaging member to take up the slack in the cable as the actuator continues to operate.

12. An overhead door assembly as set forth in claim 9 and including a switch for responsively turning off the actuator to prevent further rotation of the shaft.

13. An overhead door assembly as set forth in claim 12 wherein, said sensing and biasing mechanism includes a rotatable lever arm and further wherein, when said lever arm is moved to a predetermined position, the switch is activated.

14. An overhead door assembly as set forth in claim 13 and including a torsion spring for biasing said lever arm toward a rotatable position.

15. An overhead door assembly as set forth in claim 12 and including a sensing and biasing mechanism mounted on either side of the door to accommodate respective downwardly extending cables.

16. A mechanism for preventing the disengagement from a pulley of a cable attached to a downwardly moving door, comprising:
a cable engaging apparatus mounted near the door and having a biasing mechanism for engaging the cable such that during periods of operation in which the cable tends to become slack, the biasing mechanism moves to prevent the slackening from occurring.

17. A mechanism as set forth in claim 16 wherein said engaging apparatus is mounted near the top of said door.

18. A mechanism as set forth in claim 16 wherein an engaging apparatus is mounted on each side of the door.

19. A mechanism as set forth in claim 16 wherein the door includes a mechanized drive system and further wherein said cable engaging apparatus includes a switch for responsively shutting off the mechanized drive system.

20. A mechanism as set forth in claim 16 wherein said biasing mechanism includes an engaging member that is biased against the cable.

21. A mechanism as set forth in claim 20 wherein said engaging member comprises a pulley.

22. A mechanism as set forth in claim 20 and including a rotatable lever arm that is connected to said engaging member such that said engaging member is movable along an arc as the lever arm is rotated.

23. A mechanism as set forth in claim 22 and including a torsion spring attached to said lever arm to bias the rotation of the lever arm.
